(19) United States
(12) Patent Application Publication
(10) Pub. No.: US 2010/0206456 A1
(43) Pub. Date: Aug. 19, 2010

(54) Abrasion resistant

(76) Inventors: Joseph Loyd Vandiver, Elgin, SC (US); Harold Raymond Waynick, Sumter, SC (US)

Correspondence Address: MONAHAN & MOSES, LLC, 13-B W. WASHINGTON ST., GREENVILLE, SC, 29601, US

(21) Appl. No.: 12/378,543

(22) Filed: Feb. 17, 2009

(51) Int. Cl. B32B 37/00; C08L 95/00; B32B 13/12; B05D 7/22

(52) U.S. Cl. 156/71; 524/65; 428/451; 427/230

(57) ABSTRACT

The composite material and block system is essentially an inner sleeve that is applied to the inner walls of an emissions system in a power plant, or any other plant that generates corrosive gases as a by-product of its process, in order to provide chemical corrosion resistance, abrasion resistance and insulation. In a preferred embodiment, the novel abrasion resistant material is formed from vinyl ester resin (about 10% to about 40% by weight), coal slag (about 30% to about 70% by weight), and fly ash (about 5% to about 30% by weight).

### BACKGROUND OF THE INVENTION

The present invention relates generally to abrasion resistant blocks or bricks that may be installed in structures used to carry corrosive materials and the like, such as power plant combustion emission systems or similar plant processes. More specifically, the present invention includes a system and method for producing and installing into such systems abrasion resistant blocks or bricks that are formed from a composite material comprising vinyl ester resin, fly ash and coal slag. These composite blocks are manufactured and installed within ductwork and exhaust flues of emissions structures, forming the inner walls of the structure that are in direct contact with the corrosive materials passing through the system. The composite blocks are installed either to repair existing ductwork that has become corroded over a period of time, or in the initial manufacture of such systems in order to improve abrasion and chemical resistance of the ductwork, thus significantly extending the life and functional duration of the system.

Often, the ductwork that carries gaseous emissions from the power generator of a power plant through the environmental scrubbing process and out into the atmosphere becomes corroded and eroded through years of exposure to such gaseous emissions. For example, in Flue Gas Desulfurization (FGD) systems, the ductwork is exposed to high temperatures, high acid concentrations (including H₂SO₄), entrained and suspended particulates, and wet/dry interfaces of the condensing acids from suspension in the gaseous flue gas stream. Typically, the power plant emissions system includes a scrubber/absorber to remove sulfur dioxide, or SO₂ and other oxides of Sulphur and Nitrogen as well as chlorides. These gases are generally exposed to an aqueous neutralization stream in the scrubber, causing a reaction with the sulfur dioxide, which can produce calcium sulfite, calcium sulfate and sulfuric acid and other detrimental exposures. The SO₂, SO₃, and H₂SO₄ can cause significant corrosion of the emission system structure, including the ductwork.

When the emissions systems of power plants, or other similar structures, become corroded, eroded or otherwise degraded from years of exposure to such conditions, it becomes necessary to repair and maintain these systems. Replacing such systems can be prohibitively expensive, so other means for extending the life of the emissions systems and ductwork have been developed. One way that has been utilized commercially to extend the life of these systems is by providing a liner within the ductwork and system. These liners are typically applied to the inside of the ducts, tanks, pipes, and other structures used to carry the gaseous emissions, and the liners may be comprised of resinous liners such as polyester, vinyl ester, epoxies, and/or urethane as well as borosilicate blocks and potassium silicate gunnites. These liners are used to protect the emissions structures primarily against chemical corrosion which can be exacerbated by temperature gradients across the walls of the ductwork that cause condensation of acids in the ductwork.

One disadvantage to using resinous liners for these applications is that they do not typically provide the necessary insulation against temperature gradients and associated acid condensation, which can lead to the increased likelihood of corrosion, cracks and general degradation of the emission transmission structure.

The borosilicate blocks are used to form walls and protective structures that are built up against the inner walls of the emissions structure. These borosilicate blocks offer increased insulative properties and thus a reduction in condensation of acids, but do not provide significant abrasion resistance, thereby reducing their effective lifespan within the system. Alternatively, the silicate gunnite materials may applied directly to the inner walls of the emissions structure in areas where the abrasion is expected to be significant but fail to yield a life expectancy similar to that of the borosilicate blocks that are not exposed to abrasion and thus required repair and replacement or contribute to the premature failure of the system.

Within the emissions structures are areas that experience increased turbulence, which are usually caused by the shape of the structure itself. In these “target zones”, the gas flow is redirected in a different direction (such as a turn in the ductwork), and the corrosive gases directly impact the walls of the structure. Thus, the target zones show increased evidence of erosion due to the abrasion created by the more direct impact angles of the corrosive and abrasive gas flow. Increased abrasion resistance is required in the target zones, in order to increase the functional life of the emissions systems in these areas.

Thus, it would be desirable to provide a material that could be formed into blocks and applied within emissions structures, in order to increase abrasion resistance and adequate insulation, particularly in the target zones. It would also be desirable to provide a method for installing such abrasion resistant materials within such structures.

### OBJECTS OF THE INVENTION

Therefore, it is an object of the present invention to provide an abrasion resistant material for installation against the interior surfaces of power plant emissions structures, in order to form an inner sleeve that increases resistance to chemical corrosion, abrasion and erosion, and provides significant insulation to such structures.

Additionally, it is an object of the present invention to provide a composite material that may be formed into blocks, wherein the composite includes vinyl ester resin, fly ash and coal slag.

Further, it is an object of the present invention to provide a composite material that may be installed directly and adhered to other lining materials installed in such a way as to form an additional, abrasion resistant layer to form a composite insulative and abrasion resistant protective system.

### SUMMARY OF THE INVENTION

In a preferred embodiment, the abrasion resistant material is formed from vinyl ester resin (about 10% to about 40% by weight), coal slag (about 30% to about 70% by weight), and fly ash (about 5% to about 30% by weight). In order to prepare the material, the vinyl ester resin is mixed together with the fly ash, coal slag and a curing catalyst. Additional aggregates may be included, including powdered ceramics or vermiculite (preferably up to about 10% by weight) for additional abrasion resistance, weight reduction and increased insulative properties, when necessary.

The mixture is then cast into molds that provide a texturized mounting surface on one side, so that an adhesive layer may be applied thereto, which helps to form a strong bond during installation. The composite material is then cured at 150 F for several hours. After curing, the composite material is removed from the mold and cut into blocks of desired size and shape, using commercially available saws and blades. These blocks may then be applied to the inner surfaces of an emissions structure (or to the inner walls of any structure that requires such abrasive resistant and insulative properties) by using commercially available corrosion inhibiting adhesives, grouts and mortars.

In one embodiment, the blocks may be formed as a single-layer with the homogenous mixture as set forth above. In another embodiment, the blocks may be formed as a dual-layer composite, wherein an outer layer is the vinyl ester resin/fly ash/coal slag mixture as set forth above, and an inner layer is formed from other commercially available materials, such as borosilicate block, brick, or any other suitable material. In use, the dual-layer composite blocks are oriented and installed within the structure so that the inner layer is adhered to the existing structure, and the outer layer is exposed to the corrosive gas flow.

In order to install the composite blocks into an emissions structure, the blocks are adhered to the inner faces of existing walls, ceilings and/or floors of the structure. The blocks are preferably staggered, similarly to the arrangement of a standard brick wall, for increased structural integrity. Essentially, the blocks are used to form an inner sleeve within the existing emissions structure, where the inner sleeve comprises walls formed from the composite blocks. Commercially available corrosion inhibiting adhesives, grouts and mortars may be used for such installation.

In an alternate embodiment, the composite material may be applied or installed in-situ to form a laminate over the existing inner surfaces (including surfaces made from concrete, steel, brick, block, or any existing inner surface) of the emissions structure. In this case, the material is applied via trowel or a similar instrument while the material is in an uncured state. Then, the composite material is allowed to cure after installation. This arrangement allows more flexibility with respect to the desired thickness of the laminate, and still provides the enhanced physical characteristics inherent in the materials, including insulative and abrasion resistant properties. Further, the material may be applied to a pre-existing liner or inner sleeve consisting of, for instance, borosilicate blocks, in order to enhance the abrasion resistant qualities of the emission structure.

### BRIEF DESCRIPTION OF THE DRAWINGS

These and other features, aspects, and advantages of the present invention will become better understood with regard to the following description, appended claims, and accompanying drawings where:

FIG. 1 is a perspective cut-away view of one embodiment of the abrasion resistant block sleeve installed within a duct of an emissions system;

FIG. 2 is a perspective cut-away view of a target zone within an emissions system, where a duct directs the gas flow into a rounded chamber that includes an inner sleeve comprising a composite block wall for increased abrasion resistance;

FIG. 3 is a perspective cut-away view of the target zone shown in FIG. 2, and further showing the composite block system installed within the duct; and

FIG. 4 is a perspective view of a dual-layer composite block.

### DETAILED DESCRIPTION OF THE INVENTION

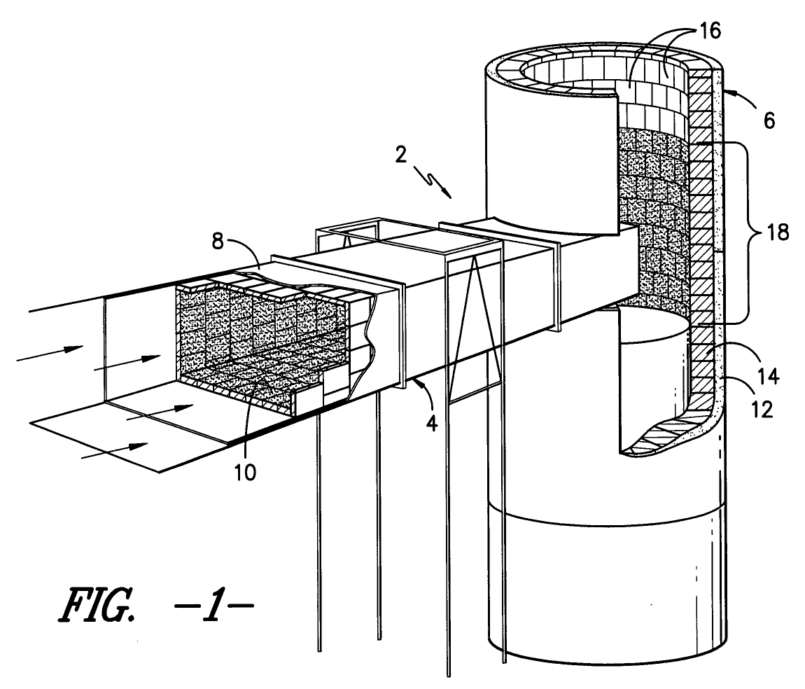

A first embodiment of the abrasive resistant composite block system is shown in FIG. 1. The composite block system is essentially a protective inner sleeve (10, 14) that is applied to the inner walls of an emissions system or structure 2 in a power plant, or any other plant that generates corrosive gases as a by-product of its process. Typically, these emissions structures 2 are formed of steel or cementitious construction materials. The inner sleeve (10, 14) comprises composite blocks formed from vinyl ester resin (about 10% to about 40% by weight), coal slag (about 30% to about 70% by weight), and fly ash (about 5% to about 30% by weight).

In order to prepare the composite material, the vinyl ester resin is mixed together with the fly ash, coal slag and a curing catalyst. Examples of preferred catalysts include diaroyl peroxide, tertiary alkyl hydroperoxides, and alkyl peresters of percarboxylic acids, although other known catalysts may be used. Additional aggregates may be included, including powdered ceramics or vermiculite (preferably up to about 10% by weight) for increased abrasion resistance, weight reduction and increased insulative properties, when necessary. One advantage to these particular materials is that fly ash and coal slag are waste by-products of coal powered electrical plants, which makes them inexpensive to obtain, and allows some of the waste to be recycled into productive material. Additionally, the coal slag is well suited as a component for abrasion the resistant materials described herein, because it is itself resistant to abrasion due to the high strength and angular geometry of its granules.

The mixture is then cast into molds that provide a texturized mounting surface on one side, so that an adhesive layer may be applied thereto, which helps to form a strong bond during installation. The composite material is then cured at 150 F for several hours. After curing, the composite material is removed from the mold and cut into blocks 16 of desired size and shape, using commercially available saws and blades. These blocks 16 may then be applied to the inner surfaces of an emissions structure (or to the inner walls of any structure that requires such abrasive resistant and insulative properties) by using commercially available corrosion inhibiting adhesives, grouts and mortars.

In one embodiment, the blocks 16 may be formed as a single-layer with the homogenous mixture as set forth above. In another embodiment, the blocks 16 may be formed as a dual-layer composite, wherein an outer layer (top layer) 20 is the vinyl ester resin/fly ash/coal slag mixture as set forth above, and an inner layer (bottom layer) 22 is formed from other commercially available materials, such as borosilicate block, brick, or any other suitable material. In use, the dual-layer composite blocks are oriented and installed within the structure so that the inner layer is adhered to the existing structure, and the outer layer is exposed to the corrosive gas flow.

To install the composite blocks 16 into an emissions structure 2, it may be desirable to clean the inner surfaces of the emissions structure 2 by performing abrasive blasting, such as sand blasting those surfaces. The blocks 16 are adhered to the inner faces of existing walls, ceilings and/or floors of the structure as shown in FIGS. 1-3, preferably using vinyl ester resin as an adhesive agent. It should be understood that although vinyl ester resin is a preferred adhesive agent, any suitable corrosion inhibiting adhesive may be used. The blocks 16 are preferably staggered, similarly to the arrangement of a standard brick wall, for increased structural integrity as shown in FIGS. 1-3. Mortar is used between the blocks in the normal manner. Commercially available corrosion inhibiting adhesives, grouts and mortars may be used for such installation.

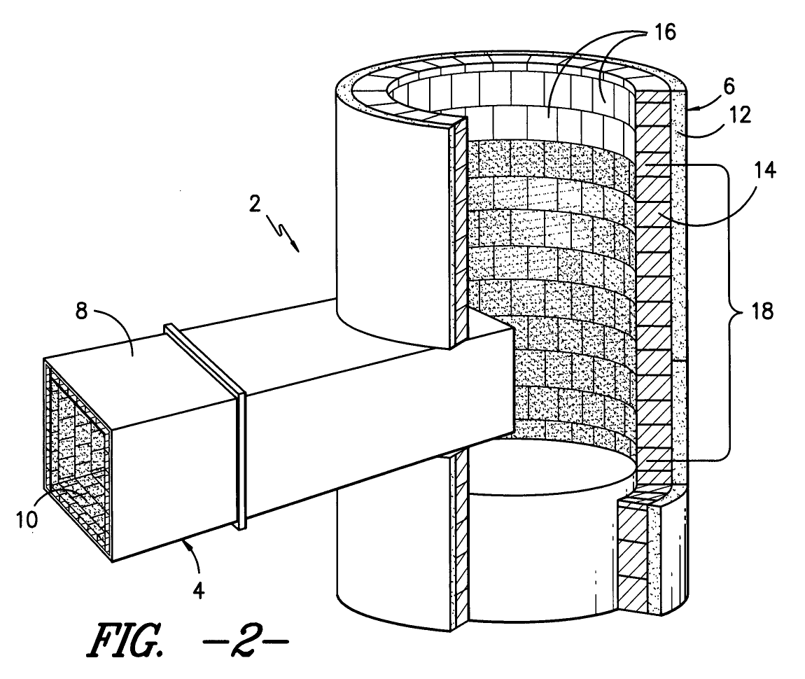

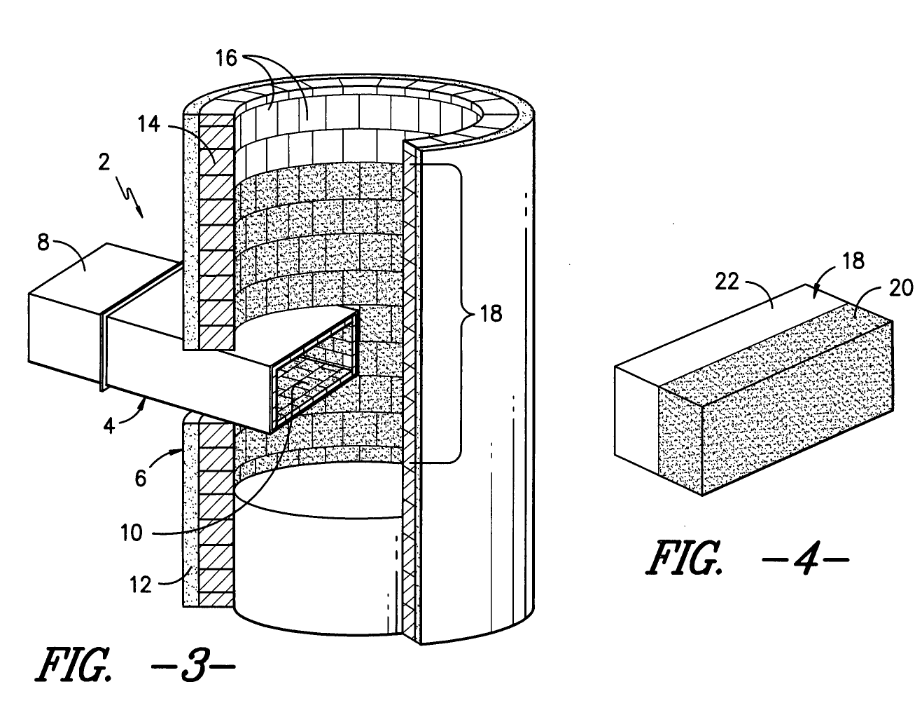

FIGS. 1-3 show a section of a common emissions structure 2 of a plant. A section of duct 4 carries emissions gases to a vertical tube 6. The duct 4 has an outer layer 8, preferably made from metal or some other suitable material, and an inner layer 10 comprising staggered blocks 16 formed from the composite material described herein, and adhered to an inner surface of the duct. The vertical tube 6 also includes an outer layer 12, again preferably made from metal or some other suitable material, and an inner layer 14 also formed from staggered blocks 16. In a preferred embodiment, there are two sections of block within the vertical tube. In the section of the vertical tube around and near the intersection with the duct, which is a hostile zone or target area 18 requiring increased abrasion resistance, the blocks include the composite material in order to enhance the abrasion resistance of the block. The blocks in other areas outside of the target zone, which do not require the same level of abrasion resistance as those within the target zone, may be formed from other materials, such as borosilicate, concrete, brick or other materials. FIGS. 2 and 3 show a target zone of an emissions structure similar to the one illustrated in FIG. 1, from different angles.

Optionally, a ceramic epoxy paste may be used as an adhesive agent for installing the blocks to the inner surfaces of the emissions structure, and may also be used in place of mortar between the blocks. Additionally, the blocks may then be overcoated with the ceramic epoxy paste layer.

In an alternate embodiment, the composite material may be applied or installed in-situ to form a laminate over the existing inner surfaces (including surfaces made from concrete, steel, brick, block, or any existing inner surface) of the emissions structure 2. In this case, the material is applied via trowel or a similar instrument while the material is in an uncured state. Then, the composite material is allowed to cure after installation. This arrangement allows more flexibility with respect to the desired thickness of the laminate, and still provides the enhanced physical characteristics inherent in the materials, including insulative and abrasion resistant properties. Further, the material may be applied to a pre-existing liner or inner sleeve consisting of, for instance, borosilicate blocks, in order to enhance the abrasion resistant qualities of the emission structure.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A composite material exhibiting anti-abrasive qualities, said composite material comprising vinyl ester resin, coal slag and fly ash.

2. The composite material set forth in claim 1, wherein said composite material comprises by weight from about 10% to about 40% vinyl ester resin, from about 30% to about 70% coal slag, and from about 5% to about 30% fly ash.

3. The composite material set forth in claim 1, further comprising a curing catalyst.

4. The composite material set forth in claim 1, further comprising material selected from the group consisting of powdered ceramics and vermiculite.

5. An abrasion resistant block made from a composite material comprising vinyl ester resin, coal slag and fly ash.

6. The abrasion resistant block set forth in claim 5, wherein said composite material comprises by weight from about 10% to about 40% vinyl ester resin, from about 30% to about 70% coal slag, and from about 5% to about 30% fly ash.

7. The abrasion resistant block set forth in claim 5, wherein said composite material further comprises a curing catalyst.

8. The abrasion resistant block set forth in claim 5, wherein said composite material further comprises material selected from the group consisting of powdered ceramics and vermiculite.

9. A dual layer abrasive resistant block comprising:
a first layer comprising a composite material including vinyl ester resin, coal slag and fly ash; and
a second layer attached to said first layer, said second layer comprising material selected from the group consisting of borosilicate, brick and concrete.

10. The dual layer abrasive resistant block set forth in claim 9, wherein said composite material comprises by weight from about 10% to about 40% vinyl ester resin, from about 30% to about 70% coal slag, and from about 5% to about 30% fly ash.

11. The dual layer abrasive resistant block set forth in claim 9, wherein said composite material further comprises a curing catalyst.

12. The dual layer abrasive resistant block set forth in claim 9, wherein said composite material further comprises material selected from the group consisting of powdered ceramics and vermiculite.

13. A process for installing an abrasion resistant inner sleeve to the inner surfaces of a structure used to carry corrosive materials and the like, said process comprising the steps of:
cleaning said inner surfaces of said structure;
applying an adhesive agent to said inner surfaces of said structure;
adhering abrasion resistant blocks, comprising a composite material including vinyl ester resin, fly ash and coal slag, to said inner surfaces of said structure; and
applying adhesive, grout or mortar, or some combination thereof, between said abrasion resistant blocks.

14. The process set forth in claim 13, further including the step of applying a ceramic epoxy paste to the outer surfaces of said abrasive resistant blocks.

15. The process set forth in claim 13, wherein said composite material of said abrasion resistant blocks comprises by weight from about 10% to about 40% vinyl ester resin, from about 30% to about 70% coal slag, and from about 5% to about 30% fly ash.

16. The process set forth in claim 13, wherein said composite material of said abrasion resistant blocks further comprises a curing catalyst.

17. The process set forth in claim 13, wherein said composite material of said abrasion resistant blocks further comprises material selected from the group consisting of powdered ceramics and vermiculite.

18. The process set forth in claim 13, wherein said abrasion resistant blocks are dual layer blocks comprising a first layer of a composite material including vinyl ester resin, fly ash, and coal slag, and a second layer attached to said first layer comprising material selected from the group consisting of borosilicate, brick and concrete.

19. The process set forth in claim 13, wherein said adhesive agent is selected from the group consisting of vinyl ester resin and a ceramic epoxy paste.

20. The process set forth in claim 13, wherein the step of cleaning said inner surfaces of said structure include abrasive blasting of said inner surfaces.

21. A process for installing an abrasion resistant inner sleeve to the inner surfaces of a structure used to carry corrosive materials and the like, said process comprising the steps of:
cleaning said inner surfaces of said structure;
applying a composite material comprising vinyl ester resin, coal slag and fly ash to said inner surfaces of said structure; and
allowing said composite material to cure.

22. The process set forth in claim 21, wherein said composite material comprises by weight from about 10% to about 40% vinyl ester resin, from about 30% to about 70% coal slag, and from about 5% to about 30% fly ash.

23. The process set forth in claim 21, wherein said composite material further comprises a curing catalyst.

24. The process set forth in claim 21, wherein said composite material further comprises material selected from the group consisting of powdered ceramics and vermiculite.

25. The process set forth in claim 21, wherein the inner surfaces of said structure comprise a pre-existing liner comprising borosilicate blocks.
